(19) United States
(12) Patent Application Publication
(10) Pub. No.: US 2008/0305000 A1
(43) Pub. Date: Dec. 11, 2008

(54) ALUMINUM-MAGNESIUM-SILVER BASED ALLOYS

(76) Inventors: Iulian Gheorghe, Canton, GA (US); Victor B. Dangerfield, Canton, GA (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/119,308

(22) Filed: May 12, 2008

Related U.S. Application Data
(60) Provisional application No. 60/917,445, filed on May 11, 2007.

(51) Int. Cl. C22C 21/08; C22C 21/06; B64C 1/00; B64C 3/00; B64C 7/00

(52) U.S. Cl. 420/532; 420/543; 420/544; 244/117 R; 244/119; 244/123.1

(57) ABSTRACT

Al—Mg—Ag wrought products and methods of making such products useful in aircraft applications. The Al—Mg—Ag wrought products have improved strength when compared to traditional AA5XXX alloys. The alloys may comprise from about 3.5 to about 10 weight percent Mg, from about 0.05 to about 0.5 weight percent Ag, from about 0.01 to about 1.0 weight percent Mn, from about 0.01 to about 0.15 weight percent Zr, and the remainder Al and incidental impurities. In addition, from about 0.05 to about 0.4 weight percent Sc may be added to further improve the strength characteristics.

### CROSS-REFERENCE TO RELATED APPLICATION

This application claims the benefit of U.S. Provisional Application No. 60/917,445 filed May 11, 2007, which is incorporated herein by reference.

### FIELD OF THE INVENTION

The present invention relates to aluminum-magnesium alloys with silver additions.

### BACKGROUND INFORMATION

Aluminum alloys containing magnesium as the principal alloying element, also known as AA5XXX alloys, exhibit very good corrosion resistance but lack the tensile and compressive strength required to make them usable in structural parts of aircraft. In order to address this issue, scandium additions have been made to AA5XXX alloys. The role of scandium is to promote the formation of fine Al₃Sc dispersoids that pin down dislocation and sub-grain movement and therefore increase the strength of the alloy. One of the disadvantages of using scandium dispersoids is the fact that Al₃Sc precipitation takes place very rapidly below typical metal processing temperatures, therefore making such alloys susceptible to coarsening. Once coarsening of Al₃Sc takes place, the strength increase due to scandium additions is irreversibly lost.

Examples of conventional alloys are disclosed in U.S. Pat. Nos. 4,927,470, 5,066,342, 5,597,529, 5,601,934 and 6,139,653, and Published U.S. Application No. 2004/0091386A1, all of which are incorporated herein by reference.

### SUMMARY OF THE INVENTION

This invention relates to Al—Mg—Ag wrought products and methods of making the same useful in aircraft applications. Further, the invention relates to Al—Mg—Ag wrought products having improved strength when compared to traditional Al—Mg alloys.

In accordance with the present invention, silver additions can accomplish a strength increase in 5XXX aluminum alloys similar to those of Sc while providing a more “processing friendly” environment. The additional strengthening is caused by the formation of Ag₂Al precipitates and disordered Ag clusters in the Al—Mg solid solution. The benefit of Ag additions results from the fact that Ag₂Al precipitation is a more controllable process than Al₃Sc precipitation. Furthermore, Ag₂Al precipitation is reversible via solution heat treating. One of the common problems encountered in Sc containing AA5XXX alloys is the fact that Al₃Sc starts precipitating very rapidly during the hot working operation and leads to substantial strain hardening of the matrix making the processing of such alloy very difficult and impossible for certain profiles like extrusions with a high extrusion ratio. On the other hand, the use of Ag in AA5XXX alloys allows for a much more friendly processing as Ag₂Al precipitation during the hot working process is much slower therefore preserving lower metal flow stress and enhancing the workability of the alloy.

It is an object of the invention to provide an improved Al—Mg—Ag wrought product for use in aircraft.

It is another object of the invention to provide an Al—Mg—Ag wrought product having improved strength.

It is yet another object of the invention to provide a method for producing an Al—Mg—Ag wrought product having improved strength properties, fracture toughness and resistance to fatigue crack growth.

It is still another object of the invention to provide a method for producing an Al—Mg—Ag alloy having improved strength properties, fracture toughness, good levels of corrosion resistance.

It is another object of this invention to provide aerospace structural members such as extrusions from the alloy of the invention.

It is another object of this invention to provide aerospace structural members such as sheet and plate from the alloy of the invention.

In accordance with these objects, the present invention comprises alloys, and products made therefrom, comprising from about 3.5 to about 10 weight percent Mg, from about 0.05 to about 0.5 weight percent Ag, from about 0.01 to about 1.0 weight percent Mn, from about 0.01 to about 0.15 weight percent Zr, the remainder aluminum and incidental elements and impurities. In one embodiment, from about 0.01 to about 0.8 weight percent Cu as well as from about 0.01 to about 1.0 weight percent Zn may be added to the alloy. In another embodiment, from about 0.05 to about 0.2 or 0.4 weight percent Sc may be added to the alloy. In a further embodiment, the alloy may be substantially free of such Cu, Zn and/or Sc additions, i.e., such additions are not purposefully added to the alloys and are only present in trace amounts or as impurities.

The invention also includes an improved aluminum base alloy wrought product such as an extrusion or flat rolled product consisting essentially of from about 3.5 to about 10 weight percent Mg, from about 0.05 to about 0.5 weight percent Ag, from about 0.01 to about 1.0 weight percent Mn, from about 0.01 to about 0.15 weight percent Zr, from about 0.05 to about 0.2 weight percent Sc, max. 0.15 weight percent Si, max. 0.15 weight percent Fe, and the remainder aluminum and incidental elements and impurities.

These and other objects of the present invention will be more apparent from the following description.

### DETAILED DESCRIPTION

The present invention provides Al—Mg—Ag based alloys, and products made therefrom, in which additional elements are added to the alloys to increase strength. It has been discovered previously that the addition of Sc to Al—Mg alloys (also known as AA5XXX alloys) increases the strength of these alloys and improves their ability to retain their strength after creep annealing. In the Al—Mg—Sr alloy systems, the additional increase in strength is achieved via Al₃Zr dispersoid precipitation. The Al₃Zr dispersoids pin down the dislocations and sub-grain boundaries, thereby increasing the strain hardening behavior of the alloy and ultimately increasing the strength of the alloy. However, one of the major drawbacks of the Sr containing AA5XXX alloys is the fact that the Al₃Zr dispersoid precipitation occurs at temperatures lower than the metal processing temperature. As a result, Al₃Zr will precipitate during the hot plastic deformation process. This can lead to un-uniform metal properties across the finished product. Al₃Zr precipitation during the metal fabrication process may also lead to severe work hardening of the material which may make it impossible to be processed thru all the manufacturing steps or may limit the applicability of the process to a limited number of profiles that can be manufactured.

One other difficulty encountered by Sc containing AA5XXX alloys is the coarsening of Sc during the hot plastic deformation process. During hot plastic deformation of Al—Mg—Sc alloys, the temperature of the material being processed can rise above its starting temperature and reach values that will favor the coarsening of the Al₃Zr, and therefore a degradation in mechanical properties. This phenomena occurs quite frequently in situations where the hot plastic deformation is more severe.

In accordance with the present invention, the role of Sc is replaced by Ag. There is, however, a fundamental difference between the formation mechanism of the two types of precipitates. Al₃Zr is a dispersoid type precipitate, and its formation is characterized by a fast aging kinetics and the impossibility of re-solutionizing the precipitate once formed. In contrast, Ag₂Al precipitates at a slower rate, and these precipitates can be dissolved in the matrix by heating the alloy at temperatures below the melting point, typically in temperature ranges between 860° F. and 1,000° F. Al₃Zr precipitates will only dissolve at temperatures above the melting temperature of the alloy. An advantage presented by the Ag additions is the ability to better control the precipitation of Ag₂Al and the ability to dissolve the precipitate and re-precipitate it in a controlled manner.

Al—Mg alloys also known as AA5XXX alloys are conventionally known as non-heat treatable alloys, i.e., strength in this family of alloys is not achieved via precipitation strengthening, but rather via work hardening. Furthermore, exposing AA5XXX alloys as well as Sc containing AA5XXX alloys to temperatures of 860° F. to 890° F. will lead to a degradation in mechanical properties. In contrast, the present invention provides heat treatable Al—Mg alloys via Ag additions.

The alloys have the following chemical composition: 3.5 to 10 weight % Mg; 0.05 to 0.5 weight % Ag; 0.01 to 1 weight % Mn; 0.01 to 0.15 weight % Zr; and the remainder Al and incidental impurities.

Silver additions to aluminum-magnesium alloys provide improved corrosion resistance and strength. The formation of AlAg₂ inside the grains acts as nucleating sites for A1₄₅Mg₂₈ precipitates. The silver additions stabilize the alloy at elevated temperatures and prevent migration and re-precipitation of alloying elements at the grain boundaries, thereby improving inter-granular corrosion resistance. Silver additions also produce a precipitation hardening effect, thereby enhancing strength of the alloys.

Manganese and zirconium act as grain refiners and may also serve as recrystallization inhibitors.

The Al—Mg—Ag alloys of the present invention are distinct from conventional 5XXX series alloys because they are susceptible to heat treatment. Under normal conditions, traditional 5XXX series alloys are not considered to be heat treatable. However, the present Al—Mg—Ag alloys exhibit improved properties when subjected to solution heat treatment, quenching, working such as stretching, and aging. For example, the following production path may be used: casting; homogenizing; extrusion or rolling; heat treatment followed by rapid cooling; cold working; and age hardening.

Whereas particular embodiments of this invention have been described above for purposes of illustration, it will be evident to those skilled in the art that numerous variations of the details of the present invention may be made without departing from the invention as defined in the appended claims.

1. An aluminum alloy consisting essentially of from about 3.5 to about 10 weight percent Mg, from about 0.05 to about 0.5 weight percent Ag, from about 0.01 to about 1.0 weight percent Mn, from about 0.01 to about 0.15 weight percent Zr, the remainder aluminum and incidental elements and impurities.

2. The aluminum alloy of claim 1, wherein the alloy consists essentially of from about 4.0 to about 7.0 weight percent Mg.

3. The aluminum alloy of claim 1, wherein the alloy consists essentially of from about 0.2 to about 0.4 weight percent Ag.

4. The aluminum alloy of claim 1, wherein the alloy consists essentially of from about 0.5 to about 0.8 weight percent Mn.

5. The aluminum alloy of claim 1, wherein the alloy consists essentially of from about 0.07 to about 0.13 weight percent Zr.

6. The aluminum alloy of claim 1, wherein the alloy further comprises from about 0.1 about about 1.5 weight percent Cu and from about 0.1 to about 1.5 weight percent Zn.

7. The aluminum alloy of claim 1, wherein the alloy further comprises from about 0.05 to about 0.2 weight percent Sc.

8. The aluminum alloy of claim 1, wherein the alloy is in the form of an extruded product.

9. The aluminum alloy of claim 1, wherein the alloy is in the form of a sheet or plate product.

10. The aluminum alloy of claim 1, wherein the alloy is in the form of a forged product.

11. An aircraft structural member comprising the aluminum alloy of claim 1.

12. A fuselage stringer comprising the aluminum alloy of claim 1.

13. A fuselage sheet member comprising the aluminum alloy of claim 1.

14. A wing rib member comprising the aluminum alloy of claim 1.

15. An extruded alloy product comprising an aluminum alloy consisting essentially of from about 3.5 to about 10.0 weight percent Mg, from about 0.05 to about 0.5 weight percent Ag, from about 0.01 to about 1.0 weight percent Mn, from about 0.01 to about 0.15 weight percent Zr, maximum 0.15 weight percent Fe, maximum 0.15 weight percent Si, and the remainder aluminum and incidental elements and impurities.

16. The extruded alloy product of claim 15, wherein the alloy consists essentially of from about 4.0 to about 7.0 weight percent Mg.

17. The extruded alloy product of claim 15, wherein the alloy consists essentially of from about 0.2 to about 0.4 weight percent Ag.

18. The extruded alloy product of claim 15, wherein the alloy consists essentially of from about 0.5 to about 0.8 weight percent Mn.

19. The extruded alloy product of claim 15, wherein the alloy consists essentially of from about 0.07 to about 0.13 weight percent Zr.

20. The extruded alloy product of claim 15, wherein the alloy further comprises from about 0.1 to about 1.5 weight percent Cu and from about 0.1 to about 1.5 weight percent Zn.

21. The extruded alloy product of claim 15, wherein the alloy further comprises from about 0.05 to about 0.2 weight percent Sc.

22. An aircraft stringer comprising the extruded alloy product of claim 15.

23. An aircraft floor beam comprising the extruded alloy product of claim 15.

24. An aircraft frame comprising the extruded alloy product of claim 15.

25. A rolled alloy product comprising an aluminum alloy consisting essentially of from about 3.5 to about 10.0 weight percent Mg, from about 0.05 to about 0.5 weight percent Ag, from about 0.01 to about 1.0 weight percent Mn, from about 0.01 to about 0.15 weight percent Zr, maximum 0.15 weight percent Fe, maximum 0.15 weight percent Si, and the remainder aluminum and incidental elements and impurities.

26. The rolled alloy product of claim 25, wherein the alloy consists essentially of from about 4.0 to about 7.0 weight percent Mg.

27. The rolled alloy product of claim 25, wherein the alloy consists essentially of from about 0.2 to about 0.4 weight percent Ag.

28. The rolled alloy product of claim 25, wherein the alloy consists essentially of from about 0.5 to about 0.8 weight percent Mn.

29. The rolled alloy product of claim 25, wherein the alloy consists essentially of from about 0.07 to about 0.13 weight percent Zr.

30. The rolled alloy product of claim 25, wherein the alloy further comprises from about 0.1 to about 1.5 weight percent Cu and from about 0.1 to about 1.5 weight percent Zn.

31. The rolled alloy product of claim 25, wherein the alloy further comprises from about 0.05 to about 0.2 weight percent Sc.

32. An aircraft fuselage sheet comprising the rolled alloy product of claim 25.

33. An aircraft stringer comprising the rolled alloy product of claim 25.

34. An aircraft frame comprising the rolled alloy product of claim 25.
